(19) United States
(12) Patent Application Publication
(10) Pub. No.: US 2025/0262930 A1
(43) Pub. Date: Aug. 21, 2025

(54) DISPLAY CONTROL DEVICE FOR A VEHICLE, DISPLAY SYSTEM FOR A VEHICLE, DISPLAY CONTROL METHOD FOR A VEHICLE, AND PROGRAM

(71) Applicant: TOYOTA JIDOSHA KABUSHIKI KAISHA, Toyota-shi (JP)

(72) Inventors: Akira OGINO, Toyota-shi (JP); Takahiro HIROTA, Kota-cho (JP)

(21) Appl. No.: 19/175,126

(22) Filed: Apr. 10, 2025

Related U.S. Application Data
(63) Continuation of application No. 18/327,926, filed on Jun. 2, 2023.

(30) Foreign Application Priority Data
Jun. 10, 2022 (JP) 2022-094581

(51) Int. Cl. B60K 35/00; B60K 35/10; B60K 35/23; B60K 35/28

(52) U.S. Cl. CPC B60K 35/00; B60K 35/10; B60K 35/23; B60K 35/28; B60K 2360/149; B60K 2360/179

(57) ABSTRACT

A display control device for a vehicle includes a processor configured to: acquire information relating to an obstacle in a vehicle's surroundings; perform superimposed display of information at a position of the obstacle as viewed by a vehicle occupant, at a display region provided in front of the vehicle occupant; and delete the display of the information in a case in which the vehicle occupant has perceived the obstacle in a state in which the information is displayed.

### CROSS-REFERENCE TO RELATED APPLICATION

This application is a continuation of U.S. patent application Ser. No. 18/327,926, filed Jun. 2, 2023, which is based on and claims priority under 35 USC 119 from Japanese Patent Application No. 2022-094581 filed on Jun. 10, 2022, the disclosure of which is incorporated by reference herein.

### BACKGROUND

### Technical Field

The present disclosure relates to a display control device for a vehicle, a display system for a vehicle, a display control method for a vehicle, and a non-transitory storage medium on which a program is stored.

### Related Art

Japanese Patent Application Laid-Open (JP-A) No. 2016-24573 discloses a display device for a vehicle that detects an obstacle existing in front of a vehicle, and displays the obstacle on a display portion. In the display device for a vehicle of JP-A No. 2016-24573, the period of updating the display of images is made to be shorter for obstacles to which attention should be paid, as compared with that in a case in which there is no obstacle to which attention should be paid.

In a structure that displays information relating to an obstacle directly in front of a vehicle occupant as in the above-described display device for a vehicle, the vehicle occupant can recognize the obstacle at an early stage. On the other hand, if another obstacle to which attention should be paid appears, there is the possibility that the vehicle occupant may be slow to recognize that obstacle.

### SUMMARY

The present disclosure provides a display control device for a vehicle, a display system for a vehicle, a display control method for a vehicle, and a non-transitory storage medium on which a program is stored, which enable recognition of a new obstacle at an early stage.

A first aspect of the present disclosure is a display control device for a vehicle including: an obstacle information acquisition unit configured to acquire information relating to an obstacle in a vehicle's surroundings; an information display unit configured to perform superimposed display of information at a position of the obstacle as viewed by a vehicle occupant, at a display region provided in front of the vehicle occupant; and an information deletion unit that, in a case in which the vehicle occupant has perceived the obstacle in a state in which the information is displayed, is configured to delete the display of the information.

In the display control device for a vehicle of the first aspect, information relating to an obstacle is displayed in a superposed manner in a display region provided in front of the vehicle occupant. Due thereto, the vehicle occupant can recognize an obstacle that is at the surroundings of the vehicle at an early stage.

Further, in a case in which the vehicle occupant has perceived the obstacle in a state in which information is displayed, the display of information is deleted. Due thereto, at a time when a new obstacle appears at the surroundings of the vehicle, information is displayed superposingly at only the new obstacle, and the vehicle occupant can recognize the new obstacle at an early stage. Note that what is called “displayed superposingly” here is not limited to a structure of carrying out superposed display for an obstacle that can be seen through the windshield glass, and is a concept broadly encompassing structures of displaying information in a superposed manner in images of the obstacle that are displayed on a display in the vehicle cabin, or the like.

A display control device for a vehicle of a second aspect includes, in the first aspect, a sightline direction acquisition unit configured to acquire a sightline direction of the vehicle occupant, wherein the information deletion unit deletes the display of the information in a case in which a sightline direction of the vehicle occupant, which has been acquired by the sightline direction acquisition unit, has been directed toward the obstacle for a predetermined time.

In the display control device for a vehicle of the second aspect, in a case in which the vehicle occupant looks at the obstacle for a predetermined time, the display of the information is deleted. Due thereto, the vehicle occupant does not carry out a special operation in order to delete the display.

A display control device for a vehicle of a third aspect includes, in the first aspect, a steering direction acquisition unit configured to acquire a steering direction of the vehicle, wherein the information deletion unit deletes the display of the information in a case in which the steering direction of the vehicle, which has been acquired by the steering direction acquisition unit, is a direction of moving away from the obstacle.

In the display control device for a vehicle of the third aspect, in a case in which the vehicle is steered by the vehicle occupant in a direction of moving away from the obstacle, it is considered that the vehicle occupant has recognized the obstacle, and the display of the information is deleted. Due thereto, the display can be deleted merely by the vehicle occupant operating the steering wheel.

A display control device for a vehicle of a fourth aspect includes, in the first aspect, an acceleration acquisition unit configured to acquire an acceleration of the vehicle, wherein the information deletion unit deletes the display of the information in a case in which the acceleration of the vehicle, which has been acquired by the acceleration acquisition unit, has decreased by a predetermined amount or more.

In the display control device for a vehicle of the fourth aspect, in a case in which the vehicle is decelerated by the vehicle occupant, it is considered that the vehicle occupant has recognized the obstacle, and the display of the information is deleted. Due thereto, the display can be deleted merely by the vehicle occupant operating the brake pedal.

In a display control device for a vehicle of a fifth aspect, in the first aspect, the display region comprises a portion of a windshield glass onto which images are projected in front of a sightline of a driver by a head-up display device.

In the display control device for a vehicle of the fifth aspect, information relating to the obstacle is displayed on a portion of the windshield. Due thereto, information relating to the obstacle can be recognized even without the vehicle occupant greatly moving his/her sightline that is directed toward the region in front of the vehicle.

A sixth aspect of the present disclosure is a display system for a vehicle including: the display control device for a vehicle of any one of claims 1 through 5; and a head-up display device configured to project images onto a windshield glass.

In the display system for a vehicle of the sixth aspect, information relating to an obstacle is displayed by the head-up display device projecting images onto the windshield. Further, due to the projecting of images from the head-up display device onto the windshield being stopped by the function of the information deleting unit, information relating to the obstacle can be set in a non-displayed state.

A seventh aspect of the present disclosure is a display control method for a vehicle including: acquiring information relating to an obstacle that is in a vehicle's surroundings; displaying information at a position of the obstacle as viewed by a vehicle occupant, at a display region within a vehicle cabin; and in a case in which the vehicle occupant has perceived the obstacle in a state in which the information is displayed, deleting display of the information.

A non-transitory storage medium that stores a program of an eighth aspect is a non-transitory storage medium on which is stored a program executable by a computer in order to execute processings including: acquiring information relating to an obstacle that is in a vehicle's surroundings; displaying information at a position of the obstacle as viewed by a vehicle occupant, at a display region within a vehicle cabin; and in a case in which the vehicle occupant has perceived the obstacle in a state in which the information is displayed, deleting display of the information.

In accordance with the display control device for a vehicle, the display system for a vehicle, the display control method for a vehicle, and the non-transitory storage medium on which a program is stored which relate to the present disclosure, a vehicle occupant can be made to recognize a new obstacle at an early stage.

### BRIEF DESCRIPTION OF THE DRAWINGS

Exemplary embodiments of the present disclosure will be described in detail based on the following figures, wherein:

FIG. 1 is a schematic drawing in which the front portion of a cabin interior of a vehicle, to which a display system for a vehicle relating to an exemplary embodiment is applied, is seen from a vehicle rear side;

FIG. 2 is a block drawing illustrating hardware structures of a display control device for a vehicle relating to the exemplary embodiment;

FIG. 3 is a block drawing illustrating functional structures of the display control device for a vehicle relating to the exemplary embodiment;

FIG. 4 is a drawing illustrating an example of display of a display region in the exemplary embodiment, and illustrates an example in which information for a first obstacle is displayed;

FIG. 5 is a drawing illustrating an example of display of the display region in the exemplary embodiment, and illustrates an example in which the information for the first obstacle is deleted;

FIG. 6 is a drawing illustrating an example of display of the display region in the exemplary embodiment, and illustrates an example in which information for a second obstacle is displayed; and

FIG. 7 is a flowchart illustrating an example of the flow of display control processing in the exemplary embodiment.

### DETAILED DESCRIPTION

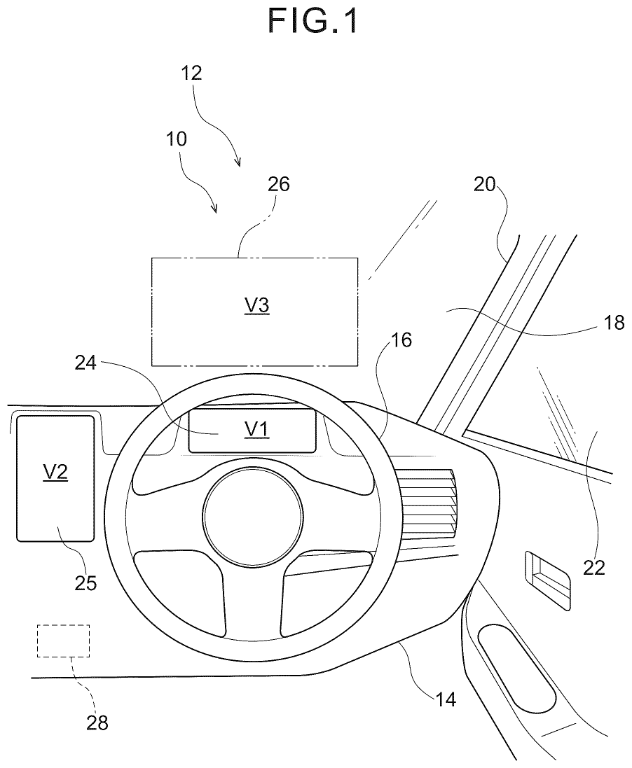

A display system 10 for a vehicle relating to an exemplary embodiment is described with reference to the drawings. Note that arrow UP illustrated in FIG. 1 indicates the upper side in the vehicle vertical direction, and arrow RH indicates the right side in the vehicle transverse direction. The vertical direction and the left-right direction in the following explanation mean upward and downward in the vehicle vertical direction and leftward and rightward in the vehicle transverse direction, respectively.

As illustrated in FIG. 1, an instrument panel 14 is provided at the front portion of the cabin interior of a vehicle 12. The instrument panel 14 extends in the vehicle transverse direction, and a steering wheel 16 is provided at the vehicle right side of the instrument panel 14. Namely, in the present exemplary embodiment, as an example, the vehicle 12 is a right-hand-drive vehicle in which the steering wheel 16 is provided at the right side, and the driver's seat is set at the vehicle right side.

A windshield glass 18 is provided at the front end portion of the instrument panel 14. The windshield glass 18 extends in the vehicle vertical direction and the vehicle transverse direction, and divides the vehicle cabin interior and the vehicle cabin exterior from one another.

The vehicle right side end portion of the windshield glass 18 is fixed to a front pillar 20 that is at the vehicle right side. The front pillar 20 extends in the vehicle vertical direction, and the windshield glass 18 is fixed to the vehicle transverse direction inner side end portion of this front pillar 20. The front end portion of a front side glass 22 is fixed to the vehicle transverse direction outer side end portion of the front pillar 20. Note that the vehicle left side end portion of the windshield glass 18 is fixed to an unillustrated front pillar that is at the vehicle left side.

Here, a first display portion 24 having a display region VI for images is provided at the instrument panel 14. The first display portion 24 is structured by the gauge display that is provided at the vehicle right side of the instrument panel 14, at the vehicle front side of the driver's seat. The first display portion 24 is connected to various gauges installed in the vehicle 12, and is provided at a position that is within the visual field of the driver in the state in which the sightline of the driver is directed toward the vehicle front side.

A second display portion 25 that is provided with a display region V2 for images is provided at the instrument panel 14. The second display portion 25 is structured by a center display disposed at the vehicle transverse direction central portion of the instrument panel 14.

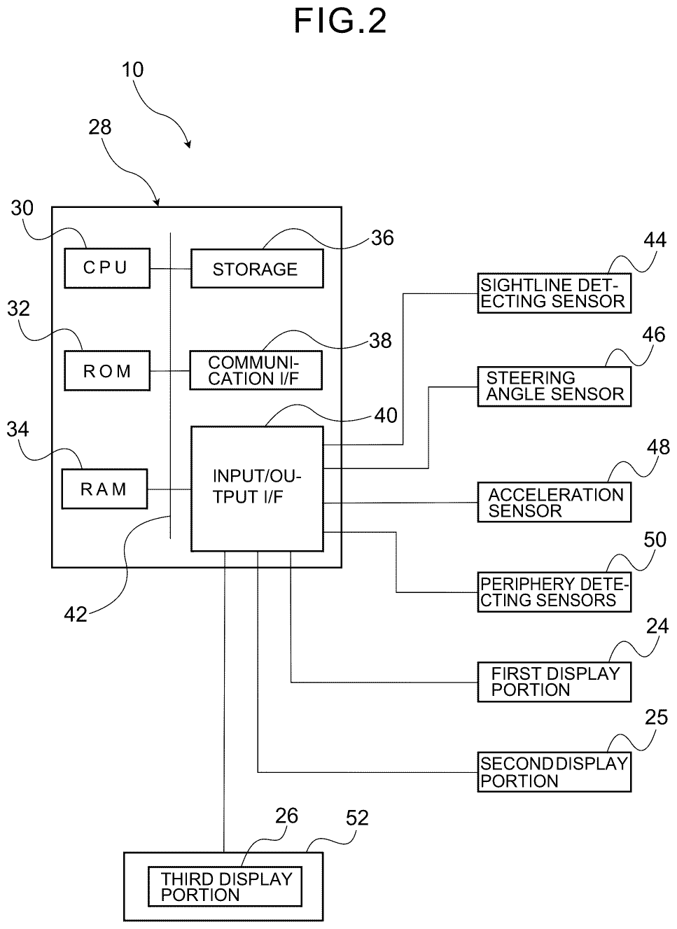

A third display portion 26 having a display region V3 for images is provided at the windshield glass 18. The third display portion 26 is set at the vehicle upper side of the first display portion 24, and is structured by a projection surface that is projected by a head-up display device 52 (see FIG. 2). Specifically, the head-up display device 52 that can project images is provided at the vehicle front side of the instrument panel 14, and is structured such that images are projected from the head-up display device 52 onto the third display portion 26 of the windshield glass 18. Namely, the third display portion 26 is a portion of the windshield glass 18 which portion is the projection surface of the head-up display device 52.

Here, a display control device 28 for a vehicle that structures the display system 10 for a vehicle is provided at the vehicle 12. The display control device 28 for a vehicle of the present exemplary embodiment is, for example, an ECU (Electronic Control Unit) that carries out various types of control.

### Hardware Structures of Display Control Device 28 for a Vehicle

As illustrated in FIG. 2, the display control device 28 for a vehicle is structured to include a CPU (Central Processing Unit: processor) 30, a ROM (Read Only Memory) 32, a RAM (Random Access Memory) 34, a storage 36, a communication interface (communication I/F) 38, and an input/output interface (input/output I/F) 40. These respective structures are connected so as to be able to communicate with one another via an internal bus 42.

The CPU 30 is a central computing processing unit, and executes various programs and controls the respective sections. Namely, the CPU 30 reads-out programs from the ROM 32 or the storage 36, and executes the programs by using the RAM 34 as a workspace. Further, the CPU 30 carries out control of the above-described respective structures, and various types of computing processings, in accordance with programs recorded in the ROM 32 or the storage 36.

The ROM 32 stores various programs and various data. The RAM 34 temporarily stores programs and data as a workspace. The storage 36 is a non-transitory recording medium that is structured by an HDD (Hard Disk Drive) or an SSD (Solid State Drive), and that stores various programs, including the operating system, and various data. In the present exemplary embodiment, a display program for carrying out display processing, and the like, are stored in the ROM 32 or the storage 36. Further, various input/output devices are connected to the input/output interface 40.

A sightline detecting sensor 44, a steering angle sensor 46, an acceleration sensor 48, periphery detecting sensors 50, the first display portion 24, the second display portion 25, and the head-up display device 52 are connected to the input/output interface 40. Further, images are projected onto the third display portion 26 by the head-up display device 52.

The sightline detecting sensor 44 is provided at the instrument panel 14 for example, and is disposed so as to be directed toward the face of the vehicle occupant (the driver) seated in the driver's seat. By recognizing an eye of the vehicle occupant, the sightline detecting sensor 44 detects the sightline direction of the vehicle occupant by using principles such as corneal reflection, scleral reflection, or the like.

The steering angle sensor 46 is a sensor that acquires the steering direction of the vehicle 12. For example, the steering angle sensor 46 acquires the steering direction of the vehicle by detecting the steering angle of the steering wheel 16. The acceleration sensor 48 detects the acceleration of the vehicle 12.

The periphery detecting sensors 50 are sensors that detect the peripheral situation of the vehicle 12. At least one sensor among various sensors such as, for example, cameras, radar, LIDAR (Light Detection and Ranging, or Laser Imaging Detection and Ranging) and the like is used as the periphery detecting sensors 50.

The cameras are structured to include a front camera capturing images of the region ahead of the vehicle, a rear camera capturing images of the region at the rear of the vehicle, and the like. The radar detects the distance and the direction to an object at the periphery of the vehicle 12 by radio waves. LIDAR detects the distance and the direction to an object at the periphery of the vehicle 12 by laser light.

### Functional Structures of Display Control Device 28 for a Vehicle

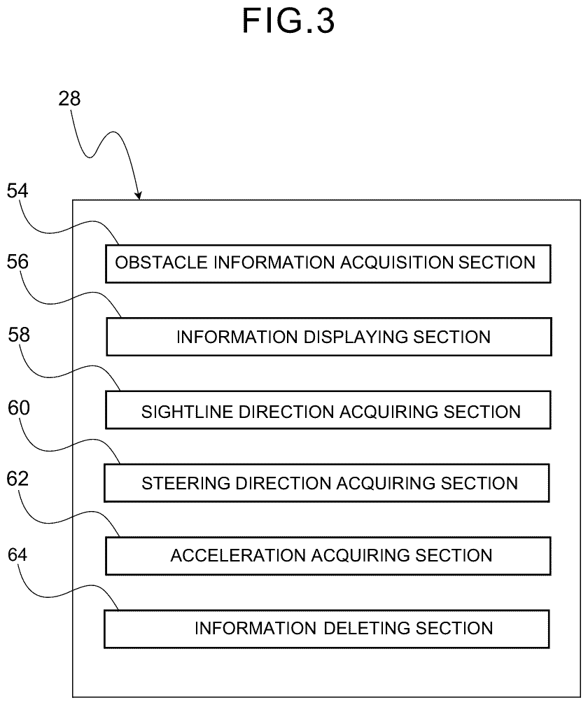

The display control device 28 for a vehicle realizes various functions by using the above-described hardware resources. Functional structures that are realized by the display control device 28 for a vehicle are described with reference to FIG. 3.

As illustrated in FIG. 3, the display control device 28 for a vehicle is structured to include, as the functional structures thereof, an obstacle information acquiring unit 54, an information displaying unit 56, a sightline direction acquiring unit 58, a steering direction acquiring unit 60, an acceleration acquiring unit 62 and an information deleting unit 64. Note that these respective functional structures are realized by the CPU 30 reading-out a program stored in the ROM 32 or the storage 36, and executing the program.

The obstacle information acquiring unit 54 acquires information relating to plural obstacles at the periphery of the vehicle. Specifically, the obstacle information acquiring unit 54 acquires information of obstacles at the periphery of the vehicle 12 that are detected by the periphery detecting sensors 50. For example, the obstacle information acquiring unit 54 acquires captured image data of the region ahead of the vehicle that has been captured by a front camera. Further, the obstacle information acquiring unit 54 acquires data relating to the positions of obstacles that are detected by radar and LIDAR and the like.

The information displaying unit 56 displays information so as to be superposed on the position of an obstacle seen from the vehicle occupant, in the display region provided in front of the vehicle occupant. In the present exemplary embodiment, as an example, the information displaying unit 56 displays information relating to an obstacle in the display region V3 of the third display portion 26. Further, in order to display an image in front of the sightline of the vehicle occupant, the information displaying unit 56 may derive the position of the superposed display on the basis of the sightline direction of the vehicle occupant that is acquired from the sightline detecting sensor 44.

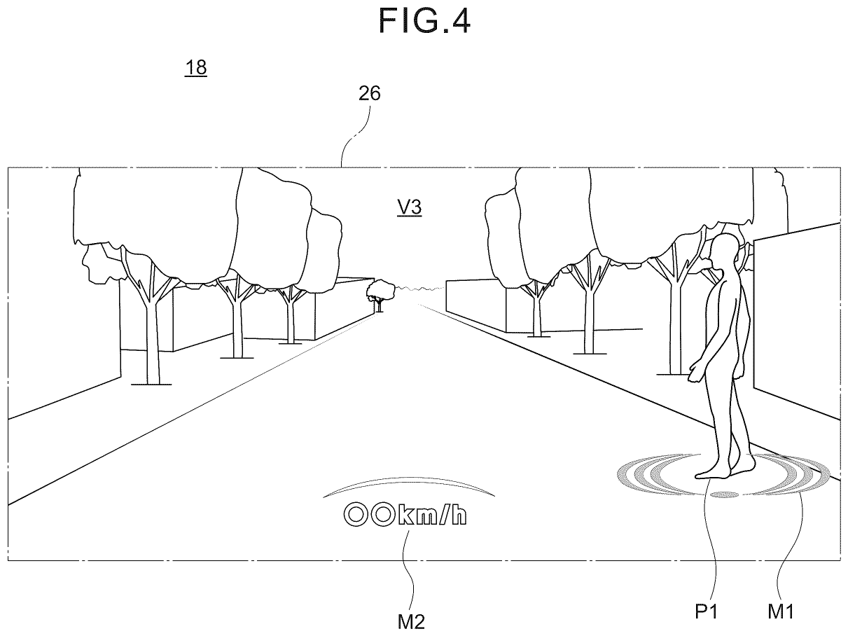

FIG. 4 is a drawing illustrating a display example in which information relating to an obstacle is displayed in the display region V3. As illustrated in FIG. 4, the view ahead of the vehicle can be seen through the windshield glass 18 at the display region V3. Note that, for convenience of explanation, only the view that can be seen in the display region V3 is illustrated, but, in actuality, the view ahead of the vehicle is not partitioned by the border of the third display portion 26.

Mark M1 and mark M2 are displayed in the display region V3 by the head-up display device 52. The mark M1 is displayed so as to be superposed at the feet of pedestrian P1 who is judged to be an obstacle from the information acquired by the obstacle information acquiring unit 54. The mark M1 of the present exemplary embodiment is displayed in a substantially circular form as an example. Note that the mark M1 is set such that the color thereof changes in accordance with the distance from the vehicle 12. For example, if pedestrian P1 is more than a predetermined distance away from the vehicle 12, the mark M1 is displayed green, and, if the pedestrian P1 is positioned a predetermined distance or less from the vehicle 12, the mark M1 is displayed red. In this way, the driver can be urged to pay attention to an individual obstacle by the mark M1.

Information relating to the obstacle may be displayed in addition to the mark M1. For example, the information displaying unit 56 may display the distance to the obstacle in a vicinity of the mark M1. Further, the information displaying unit 56 may display the type of the obstacle or the like in a vicinity of the mark M1.

The current speed of the vehicle 12 that is sensed by an unillustrated vehicle speed sensor is displayed by the mark M2. Note that the mark M2 does not have to be displayed.

The sightline direction acquiring unit 58 of FIG. 3 acquires the sightline direction of the vehicle occupant. Specifically, the sightline direction acquiring unit 58 acquires information relating to the sightline direction of the vehicle occupant that is detected by the sightline detecting sensor 44.

The steering direction acquiring unit 60 acquires the steering direction of the vehicle 12. Specifically, the steering direction acquiring unit 60 acquires information relating to the steering angle that is detected by the steering angle sensor 46.

The acceleration acquiring unit 62 acquires the acceleration of the vehicle 12. Specifically, the acceleration acquiring unit 62 acquires information relating to the acceleration of the vehicle 12 that is detected by the acceleration sensor 48.

In a case in which a predetermined condition is met in a state in which information relating to an obstacle is displayed in a display region, the information deleting unit 64 judges that the vehicle occupant has recognized the obstacle, and deletes the display of information. Specifically, in the present exemplary embodiment, as an example, in a case in which the sightline direction of the vehicle occupant that is acquired by the sightline direction acquiring unit 58 is directed toward the obstacle for a predetermined time, the information deleting unit 64 deletes the display of information. At this time, during the time when the sightline direction of the vehicle occupant is directed toward the pedestrian P1, the color or the shape or the like of the mark M1 may be changed.

Further, in a case in which the steering direction of the vehicle 12 that is acquired by the steering direction acquiring unit 60 is a direction of moving away from the obstacle, the information deleting unit 64 deletes the display of information. Note that, in a case in which the steering angle is not changed greatly before and after the pedestrian P1 who is the obstacle is detected, display may be continued even if the advancing direction of the vehicle 12 is a direction of moving away from the obstacle. Namely, the display of information may be deleted only in a case in which, after the mark M1 is displayed, the steering angle is changed by a predetermined threshold value or more, and the steering direction of the vehicle 12 becomes a direction of moving away from the obstacle.

Moreover, the information deleting unit 64 deletes the display of information in a case in which the acceleration of the vehicle 12 acquired by the acceleration acquiring unit 62 decelerates by a predetermined amount or more. Note the display of information may be deleted in a case in which the absolute value of the deceleration is greater than a predetermined value, or the display of information may be deleted in a case in which the deceleration per unit time becomes greater than or equal to a predetermined value such as at the time of sudden braking.

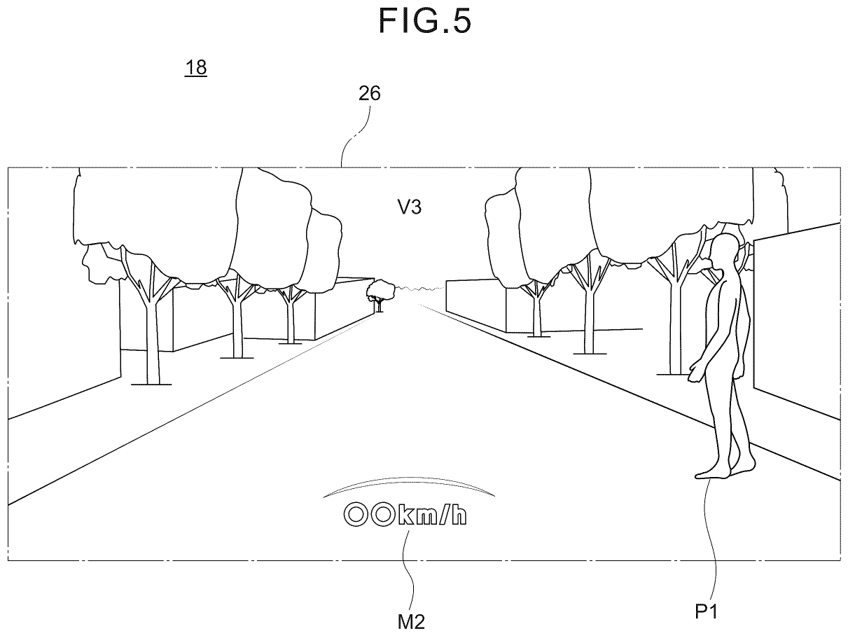

FIG. 5 is a drawing illustrating a display example in a case in which it is judged that the vehicle occupant has recognized the pedestrian P1 who is an obstacle from the state of FIG. 4. As illustrated in FIG. 5, the mark M1 that was displayed by the head-up display device 52 is deleted by the information deleting unit 64. Note that, in a case in which the distance to the obstacle or the type of the obstacle or the like is simultaneously displayed, the display of the distance or the type is also deleted together with the mark M1 by the information deleting unit 64.

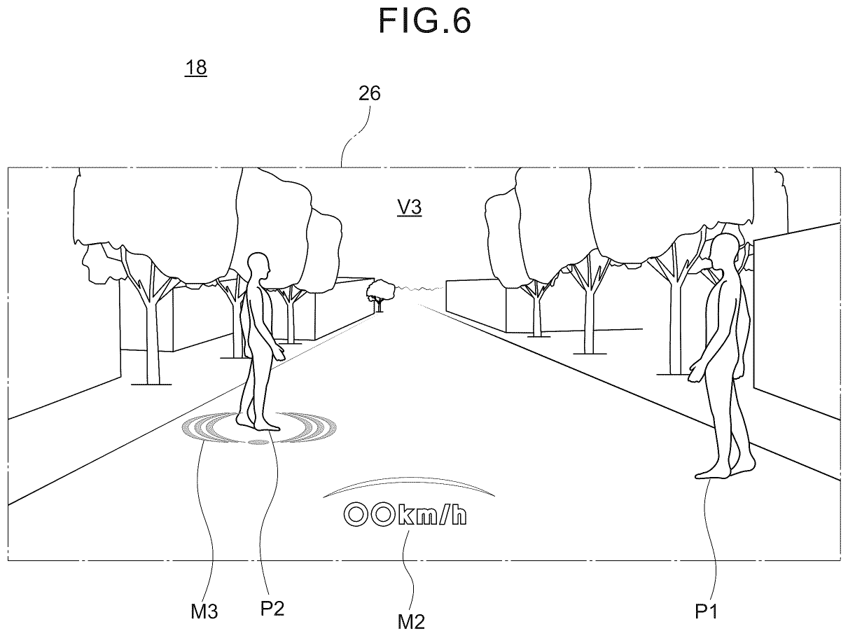

FIG. 6 illustrates a display example in a case in which, from the state of FIG. 5, a pedestrian P2 who is a new obstacle appears. As illustrated in FIG. 6, mark M3 is displayed by the head-up display device 52 in the display region V3. The mark M3 is displayed so as to be superposed at the feet of the pedestrian P2 who is judged to be an obstacle from the information acquired by the obstacle information acquiring unit 54. In the same way as the mark M1, the mark M3 of the present exemplary embodiment is displayed in a substantially circular form as an example.

### Operation

Operation of the present exemplary embodiment is described next.

### Display Control Processing

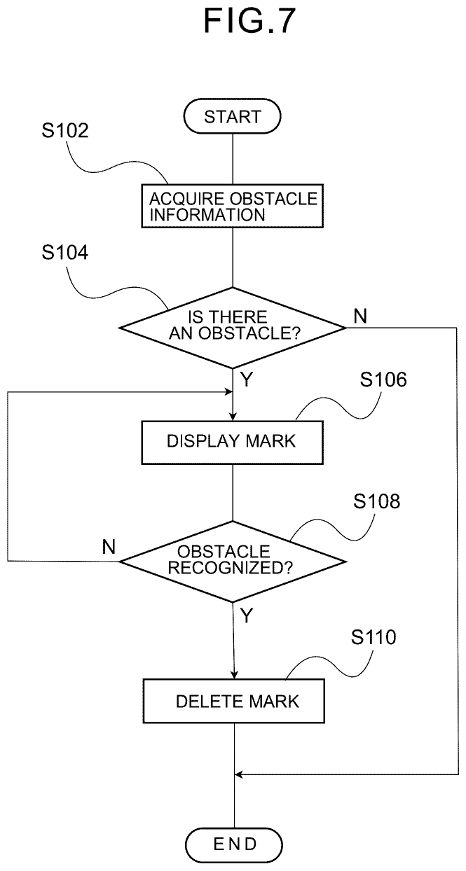

An example of display control processing that displays and deletes the mark M1 in and from the third display portion 26 that is the projection surface of the head-up display device 52 is described by using the flowchart illustrated in FIG. 7. This display processing is executed due to the CPU 30 reading-out a display program from the ROM 32 or the storage 36, and expanding and executing the display program in the RAM 34. Further, the display processing is repeatedly executed each predetermined time.

In step S102, the CPU 30 acquires information relating to obstacles. Specifically, by the function of the obstacle information acquiring unit 54, the CPU 30 acquires information such as the positions, types and the like of obstacles detected by the periphery detecting sensors 50.

In step S104, the CPU 30 judges whether or not there is an obstacle. Here, in a case in which an obstacle that should be displayed in the display region V3 is detected, the CPU 30 judges that there is an obstacle, and moves on to the processing of step S106. Because the pedestrian P1, who is walking at the front, right side of the vehicle 12, is an obstacle that should be displayed in the display region V3, the CPU 30 judges that there is an obstacle, and moves on to the processing of step S106.

On the other hand, in step S104, in a case in which an obstacle that dose not to be displayed in the display region V3 is not detected, the CPU 30 judges that there is no obstacle, and ends the display control processing. For example, even in a case in which the pedestrian P1 does not exist but an obstacle is detected at the rear of the vehicle 12 by the rear camera, the CPU 30 ends the display control processing if that obstacle is not an obstacle that should be displayed in the display region V3.

In step S106, the CPU 30 displays the mark M1 in a superposed manner on the pedestrian P1 who is the obstacle. Specifically, by the function of the information displaying unit 56, the CPU 30 displays information by projecting a predetermined image onto the display region V3 of the third display portion 26 by the head-up display device 52. The information displaying unit 56 displays the information so as to be superposed on a position of the obstacle that is seen from the vehicle occupant.

In step S108, the CPU 30 judges whether or not the vehicle occupant has recognized the obstacle. Specifically, the CPU 30 judges that the vehicle occupant has recognized the obstacle in a case in which the sightline direction of the vehicle occupant acquired by the function of the sightline direction acquiring unit 58 is directed toward the pedestrian P1 for a predetermined time.

Further, in a case in which the steering direction of the vehicle 12 acquired by the function of the steering direction acquiring unit 60 is a direction of moving away from the pedestrian P1, the CPU 30 judges that the vehicle occupant has recognized the obstacle.

Moreover, in a case in which the acceleration of the vehicle 12 acquired by the function of the acceleration acquiring unit 62 has decelerated a predetermined amount or more, the CPU 30 judges that the vehicle occupant has recognized the obstacle.

If the CPU 30 judges in step S108 that the vehicle occupant has recognized the obstacle, the CPU 30 moves on to the processing of step S110. Further, if the CPU 30 judges in step S108 that the vehicle occupant has not recognized the obstacle, the CPU 30 moves on to the processing of step S106, and continues displaying the mark M1. Note that, in a case in which an obstacle for which information is being displayed moves out of the display region, an object for which information is to be displayed no longer exists, and therefore, the mark M1 is deleted.

In step S110, the CPU 30 deletes the mark M1. Specifically, by the function of the information deleting unit 64, the CPU 30 stops the projecting of the image from the head-up display device 52 onto the display region V3. Then, the CPU 30 ends the display control processing. Note that, because the display control processing is repeatedly executed each predetermined time, in a case in which the another pedestrian P2 appears after the mark M1 is deleted in step S110, due to the display control processing being executed again and the processing proceeding from step S102 through step S106, the mark M3 is displayed so as to be superposed on the pedestrian P2.

As described above, in the display system 10 for a vehicle and the display control device 28 for a vehicle relating to the present exemplary embodiment, information relating to the obstacle is displayed in a superposed manner in the display region V3 that is provided in front of the vehicle occupant. Due thereto, the vehicle occupant can recognize an obstacle at the periphery of the vehicle at an early stage.

Further, in the state in which information is displayed in the display region V3, in a case in which the vehicle occupant recognizes the obstacle, the display of information is deleted. Due thereto, at the time when a new obstacle appears at the periphery of the vehicle, information is superposingly displayed only on that new obstacle, and the vehicle occupant can recognize the new obstacle at an early stage.

Further, in the present exemplary embodiment, the display of information is deleted in a case in which the vehicle occupant views the obstacle for a predetermined time. Due thereto, the vehicle occupant does not carry out a special operation in order to delete the display. For example, there is no need for the vehicle occupant to move his/her hand in order to delete the display.

Moreover, in the present exemplary embodiment, in a case in which the vehicle 12 is steered by the vehicle occupant in a direction of moving away from the obstacle, it is considered that the vehicle occupant has recognized the obstacle, and the display of information is deleted. Due thereto, the display can be deleted merely due to the vehicle occupant operating the steering wheel 16. Namely, the display can be deleted merely by the vehicle occupant carrying out general driving.

Still further, in the present exemplary embodiment, in a case in which the vehicle 12 is decelerated by the vehicle occupant, it is considered that the vehicle occupant has recognized the obstacle, and the display of information is deleted. Due thereto, the display can be deleted merely by the vehicle occupant operating the brake pedal.

Further, in the present exemplary embodiment, information relating to the obstacle is displayed on the display region V3 that is a portion of the windshield glass 18. Due thereto, information relating to the obstacle can be recognized even without the vehicle occupant greatly moving his/her sightline that is directed toward the region in front of the vehicle. In particular, in the present exemplary embodiment, information relating to the obstacle is displayed due to the head-up display device 52 projecting images onto the windshield glass 18 by the function of the information displaying unit 56. Further, information relating to the obstacle can be set in a non-displayed state due to the projection of images from the head-up display device 52 onto the windshield glass 18 being stopped by the function of the information deleting unit 64.

Although the display system 10 for a vehicle and the display control device 28 for a vehicle relating to an exemplary embodiment have been described above, the technique of the present disclosure can, of course, be implemented in various forms within a scope that does not depart from the gist thereof. For example, in the above-described exemplary embodiment, the information deleting unit 64 deletes the mark M1 when at least one condition among the sightline direction of the vehicle occupant is directed toward the obstacle for a predetermined time, the steering direction of the vehicle 12 is a direction of moving away from the obstacle, and the acceleration of the vehicle 12 decelerates by a predetermined amount or more, is satisfied. However, the present disclosure is not limited to this, and may be structured such that the mark MI is deleted when two of the above-described three conditions are satisfied. Or, there may be a structure in which the mark M1 is deleted only in a case in which all of the above-described three conditions are satisfied.

Further, in the above-described exemplary embodiment, the mark M1 is displayed in a substantially circular form as illustrated in FIG. 4, but the present disclosure is not limited to this. For example, an arrow-like mark may be displayed above the head of the pedestrian P. Or, separate marks that are different for pedestrians and for two-wheeled vehicles may be displayed.

Moreover, although the above exemplary embodiment describes a structure in which information is displayed in a superposed manner in the display region V3 of the third display portion 26, the present disclosure is not limited to this. For example, a structure may be employed in which information is superposingly displayed in the display region V1 of the first display portion 24 or the display region V2 of the second display portion 25. In this case, information is superposingly displayed on images of the periphery of the vehicle 12 that are captured by the front camera or the like.

What is claimed is:

1. A display control device for a vehicle, comprising a processor configured to:
acquire a position of an obstacle in a vehicle's surroundings;
determine a distance from the vehicle to the obstacle;
perform superimposed display of information at the position of the obstacle as viewed by a vehicle occupant, at a display region provided in front of the vehicle occupant, wherein the display of information is performed in a first manner if the determined distance is greater than a predetermined threshold and in a second manner if the determined distance is less than or equal to the predetermined threshold;
determine whether the vehicle occupant has perceived the obstacle; and
delete the display of the information when it is determined that the vehicle occupant has perceived the obstacle while the information is displayed so the vehicle occupant can identify a new obstacle at an early stage.

2. The display control device for a vehicle of claim 1, wherein the processor acquires a sightline direction of the vehicle occupant, and deletes the display of the information in a case in which a sightline direction of the vehicle occupant, which has been acquired, has been directed toward the obstacle for a predetermined time.

3. The display control device for a vehicle of claim 1, wherein the processor acquires a steering direction of the vehicle, and deletes the display of the information in a case in which the steering direction of the vehicle, which has been acquired, is a direction of moving away from the obstacle.

4. The display control device for a vehicle of claim 1, wherein the processor acquires an acceleration of the vehicle, and deletes the display of the information in a case in which the acceleration of the vehicle, which has been acquired, has decreased by a predetermined amount or more.

5. The display control device for a vehicle of claim 1, wherein the display region comprises a portion of a windshield glass onto which images are projected in front of a sightline of a driver by a head-up display device.

6. A display system for a vehicle, the system comprising:
the display control device for a vehicle of claim 1; and
a head-up display device configured to project images onto a windshield glass.

7. A display control method for a vehicle, the method comprising:
acquiring a position of an obstacle that is in a vehicle's surroundings;
determining a distance from the vehicle to the obstacle;
displaying information at the position of the obstacle as viewed by a vehicle occupant, at a display region within a vehicle cabin, wherein the information is displayed in a first manner if the determined distance is greater than a predetermined threshold and in a second manner if the determined distance is less than or equal to the predetermined threshold;
determining whether the vehicle occupant has perceived the obstacle; and
when it is determined that the vehicle occupant has perceived the obstacle while the information is displayed, deleting display of the information.

8. A non-transitory storage medium storing a program that is executable by a computer to execute processing comprising:
acquiring a position of an obstacle that is in a vehicle's surroundings;
determining a distance from the vehicle to the obstacle;
displaying information on a windshield of the vehicle with a heads-up-displayed device at the position of the obstacle as viewed by a vehicle occupant, at a display region within a vehicle cabin, wherein the information is displayed in a first manner if the determined distance is greater than a predetermined threshold and in a second manner if the determined distance is less than or equal to the predetermined threshold;
determining whether the vehicle occupant has perceived the obstacle; and
when it is determined that the vehicle occupant has perceived the obstacle while the information is displayed, deleting display of the information.

9. The display control device of claim 1, wherein the first manner comprises displaying the information in a first color, and the second manner comprises displaying the information in a second color.
